(19) United States
(12) Patent Application Publication
(10) Pub. No.: US 2010/0100639 A1
(43) Pub. Date: Apr. 22, 2010

(54) METHOD FOR PROVIDING INTERNET PROTOCOL HANDOFF OF MOBILE NODE UNDER MULTIPLE MOBILE AGENT PLATFORM ENVIRONMENT

(75) Inventors: Sung Soo Kang, Daejeon (KR); Seong-Gon Choi, Chungcheongbuk-do (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Instit ute, Daejeon (KR)

(21) Appl. No.: 12/443,677

(22) PCT Filed: Sep. 18, 2007
(86) PCT No.: PCT/KR07/04492

§ 371 Date: Mar. 30, 2009

(30) Foreign Application Priority Data
Sep. 29, 2006 (KR) 10-2006-0096574

(51) Int. Cl. G06F 15/173

(52) U.S. Cl. 709/242

(57) ABSTRACT

Provided is a method for providing Internet protocol (IP) handoff of a mobile node (MN) under a multiple mobile agent platform (MAP) environment. In the method, a registration request message for an IP handoff is received from an MN in a network including a plurality of MAPs, and information about the MN is shared with an MAP managing an area in which the MN is located before through a signal packet path. The signal packet path is established separately from a data packet path for transmitting signal packets associated with IP handoff. An IP handoff for the MN is provided based on the shared information. Therefore, a rapid IP handoff is possible since the two MAPs share information about the MN with each other.

### TECHNICAL FIELD

The present invention relates to a method for providing an Internet protocol (IP) handoff of a mobile node (MN) in a mobile network, and more particularly, to a method for providing an IP handoff of an MN between mobile agents (MAs) under multiple mobile agent platform (MAP) environment.

### BACKGROUND ART

Generally, in a mobile network, MAPs support regional registration and separately transmit signal packets for IP handoff and data packets. When an MN moves from a coverage area of a first MAP to a coverage area of a second MAP, the IP address of the MN may have to be changed.

For this, the first and second MAPs share information about the MN so as to perform an IP handover of the MN more rapidly. A high altitude aeronautical platform (HAAP) located higher than a base station (for example, in the stratosphere) or a virtual private network (VPN) can be used to transmit signal packets for IP handoff between such MAPs. In this case, signal packets for IP handoff can be transmitted without delay by data packet (i.e., a head of line (HOL) blocking phenomenon can be prevented), so that IP handoff can be performed rapidly.

Furthermore, in the IP handoff method using an HAAP or VPN, a registration request message addressed from a foreign agent (FA) to a home agent (HA) can be transmitted between MAPs without a change. Therefore, MNs not compatible with a gateway foreign agent (GFA) can be handed off.

In “IP-based next-generation wireless networks”, Jyh-Cheng & Tao Zhang, John Wiley & Sons Inc., 2004, “Intra-subnet handoff”, “Inter-subnet handoff”, and “Inter-router handoff” have been introduced as handoff methods for an MN. The “Inter-subnet handoff” and the “Inter-router handoff' are associated with the case where an MN requires a new IP subnet address (i.e., the MN moves from a coverage area of a Router to a coverage area of another router).

Even when an MN is handed off from one cell to another (neighboring) cell, an IP handoff is not necessary in the case where the two cells are managed by the same router. That is, a handoff in an intra-subnet is not an IP handoff since the same IP subnet address is used in the intra-subnet. When an MN moves to an area managed using a different IP address in an IP network, an FA operating as a virtual router provides a Care of Address (CoA) to the MN. Then, the MN registers the CoA in an HA. In this case, when the HA receives data destined for the MN, the HA encapsulates the data and transmits the encapsulated data to the FA using the CoA. Then, the FA decodes the data and transmits the decoded data to the MN. In this way, the FA operates as a default router of the MN so as to route data destined for the MN to the MN.

In this handoff method, signal packets for handoff and data packets can be transmitted using the same path. In this case, a head of line (HOL) blocking problem can occur between routers managing IP subnets.

In U.S. Pat. No. 7,031,709 (18 Apr. 2006), geographical FA topology has been introduced for an environment where a plurality of network providers and various wire/wireless access networks exist. In detail, a service provider having subscribers but an access network can obtain or acquire a new CoA for an MN when the MN moves from an A area to a B area in a manner such that an FA of the B area requests an available CoA for the MN through an FA of the A area. For this, the HA of the service provider forms topology for different access networks and an MAP based on the mobility history of the MN so as to predict mobility of the MN. Therefore, the MN can be rapidly handed off.

The disclosed method can be used when the structure of an access network is not known. However, it takes time for the HA to collect and learn the mobility history of the MN. Furthermore, when the MN moves, the MN acquires a CoA in a different method as compared with an existing method. In addition, the possibility of malicious attack may increase since a CoA of an FA is requested using another FA located in a different area. That is, a CoA not available in a B area can be transmitted to an HA through an FA of an A area. In this case, a denial message may be generated when a binding update is performed between the HA and an FA of the B area.

Alternatively, a regional registration method described in the Internet engineer task force (IETF) can be used for an IP handoff of an MN. In the regional registration method, a higher-level GFA than FAs having different address ranges is used to provide a CoA to an MN. However, when signal packets for IP handoff are transmitted together with IP data packets, HOL blocking (a characteristic problem of IP networking) cannot be eliminated using the regional registration method. Furthermore, an MN has to recognize a GFA and register with the GFA as well as register with an HA.

For this reason, an IP handoff method for an MN not capable of recognizing a GFA has been introduced in U.S. Patent publication No. 2005/0114543 (26 May 2005). When an MN transmits a registration request message to an HA through an FA, a GFA relays the registration request message from the FA to the HA. The GFA adds it IP address to an extension field of the registration request message of the MN received from the FA.

When an MN moves from an A area of an FA to a B area of another FA, an GFA can transmit a registration reply message to the MN in response to a registration request message of the MN if the MN is a registered MN. On the other hand, if the MN is not a registered MN, the GFA generates a new visitor entry and adds the entry to its visitor list. Further, the GFA adds its IP address to an extension field of a registration request message of the MN received from the FA of the B area and then delivers the registration request message to an HA of the MN.

In this case, the MN can registers with the HA in the same manner as in a conventional method. However, all the HA, GFA, and FA can recognize and process the address of the GFA added to the extension field of the registration request message. Furthermore, after the GFA generates a new visitor entry for a non-registered MN and adds the new entry to its visitor list before a registration reply message is received from an HA, the added visitor entry may have to be deleted again when a binding up date denial message is received later. Moreover, while the registration reply message of the HA is delayed, the MN can move to a coverage area of another FA and sends a registration request message. In this case, since the MN is already listed in the visitor list of the GFA although the MN is not actually registered, data can be transmitted to the MN. Therefore, malicious calls cannot be effectively blocked. In addition, because all data packets have to be transmitted via the GFA, data transmission paths are complicated. Furthermore, a method for processing signals for IP handoff between plural GFAs is not mentioned. Therefore, when an MN moves to another GFA, the MN has to send a registration request message again to its HA through the GFA.

Meanwhile, another IP handoff method is disclosed in U.S. Patent Publication No. 2004/0198383 (7 Oct. 2004). In the disclosed method, a paging foreign agent (PFA) supporting paging of an MN is used together with a controlling foreign agent (CFA) controlling the PFA in a hierarchical architecture in which the CFA is located above the PFA. The PFA and CFA write their addresses in an extension field of an advertisement message and send the advertisement message to an MN for an IP handoff registration request. Detailed registration procedures of the disclosed method are the same as registration procedures of a regional registration method described in the IETF in which an MN asks a CFA for a regional registration.

Therefore, when signal packets for IP handoff and data packets are transmitted together, HOL blocking (a characteristic problem of IP networking) cannot be prevented in the disclosed method. Furthermore, an MN has to recognize a GFA and asks the GFA for a registration as well as registers with an HA. In addition, registration procedures and methods are not mentioned for the case where an MN moves from a coverage area of a CFA to a coverage area of another CFA. Therefore, when an MN moves to another CFA, the MN has to send a registration request message again to its HA through the CFA.

Meanwhile, a method for supporting IP handoff in an IMT-2000 network system using an asynchronous communication scheme like in Europe is disclosed in U.S. Patent Publication No. 2002/014993 (3 Oct. 2002). A gateway GPRS (General Packet Radio Services) support node (GGSN) constituting an IMT-2000 system in consideration of connection-oriented asynchronous scheme can operates as a FA or a GFA. Furthermore, a GPRS tunneling protocol (GTP) tunnel is established between an MN and a GGSN for registering location information of an MN in an HA.

According to the disclosed method, an IP handoff of an MN can be possible using a GFA in a European IMT-2000 system. However, in this case, the MN must have an additional function for recognizing a GFA. Furthermore, all GGSNs must have a GFA function. Furthermore, since data packets are transmitted between an MN and a correspondent node through a GFA, data transmission paths increase like in the GFA method. Moreover, a method for providing handoff in a plurality of service provider (that is, a plurality of GFAs) is not mentioned.

Meanwhile, a method for providing IP handoff in Ipv6 is disclosed in U.S. Patent Publication No. 2006/0018291 (26 Jan. 2006). According to the disclosed method, a gateway router (GR) operates like a GFA, and a local mobility anchor (LMA) operates like an MA. When an MN moves between LMAs, a GR receives a CoA of the MN from an HA so as to rout data packets transmitted from a CN directly to an LMA where the MN is currently located without routing the data packets via the HA. Thus, data transmission paths can be reduced. Furthermore, since the CoA of the MN is not transmitted to the CN, the current location of the MN can be hid from the CN.

However, according to the disclosed method, data packets transmitted from the CN to the MN have to pass always through the GR. Furthermore, since data transmission paths are not separated from signal path for IP handoff, HOL blocking can occur when the same channel is used for data packets and signal packets.

In addition, a method for providing handoff in a plurality of service provider (that is, a plurality of GRs) is not mentioned in the disclosed method. Further, a communication scheme of an HA should be modified to apply the disclosed method in the IPv4 network instead of in the IPv6 network.

### DISCLOSURE OF INVENTION

### Technical Problem

The present invention has been made to solve the foregoing problems of the prior art and therefore an aspect of the present invention is to provide a method for providing a rapid Internet protocol (IP) handoff of an mobile node (MN) when an IP address of the MN is to be changed since the MN moves from a current mobile agent platform (MAP) to a neighboring MAP in a multiple MAP environment in which signal packets are transmitted separately from data packets.

Another aspect of the invention is to provide a method for providing a rapid IP handoff of an MN without an HOL blocking phenomenon (i.e., without a signal packet delay by data packets) when an IP address of the MN is to be changed since the MN moves from a current MAP to a neighboring MAP in a multiple MAP environment that supports regional registration and allows signal packets to be transmitted separately from data packets.

A further another aspect of the invention is to provide a method for providing a rapid IP handoff of an MN in a multiple MAP environment using a gateway foreign agent (GFA), whether a regional registration scheme is used or not.

### Technical Solution

According to an aspect of the invention, there is provided a method for an MAP to provide an IP handoff, the method including: receiving a registration request message for an IP handoff from a mobile node (MN) in a network including a plurality of MAPs; sharing information about the MN with an MAP managing an area in which the MN is located before through a signal packet path, the signal packet path being established separately from a data packet path for transmitting signal packets associated with IP handoff; and providing an IP handoff for the MN based on the shared information.

According to an embodiment of the invention, the signal pack path is established using one of a high altitude aeronautical platform (HAAP) located in the stratosphere and a virtual private network (VPN).

According to another embodiment of the invention, the sharing of the information about the MN includes receiving information about the MN from the MAP managing the area in which the MN is located before by using the registration request message received from the MN.

According to a further another embodiment of the invention, the registration request message includes: a head including information about a message type, flag bits, and a lifetime; a home address of the MN; a address of home agent; and a care-of address (CoA) of a foreign agent (FA).

According to another aspect of the invention, there is provided a method for an MAP to provide an IP handoff, the method including: receiving a registration request message for an IP handoff from an MN in a network including a plurality of MAPs; determining whether an entry corresponding to the MN is included in a border list; transmitting the registration request message to an MAP managing an area in which the MN is located before and a home agent (HA); receiving a registration reply message from the HA in response to the registration request message; adding an entry of the MN to a visitor list after checking the received registration reply message; and providing an IP handoff for the MN based on the entry of the MN added to the visitor list.

According to a further another aspect of the invention, there is provided a method for an MAP to provide an IP handoff, the method including: receiving a registration request message for an IP handoff from an MN through an FA; determining whether the MN is included in a visitor list; if the MN is not included in the visitor list, determining whether the MN is included in a border list; if the MN is included in the border list, transmitting the registration request message to an HA based on information about the MN; and providing an IP handoff for the MN based on information about the MN according to a registration allowance message received from the HA in response to the registration request message.

According to the invention, when an IP address of an MN is to be changed since the MN moves from a current MAP to a neighboring MAP in a multiple MAP environment that supports regional registration and allows signal packets to be transmitted separately from data packets, the two MAPs share information about the MN with each other so as to provide a rapid IP handoff for the MN.

### Advantageous Effects

According to the invention, when an Internet (IP) address of a mobile node (MN) is to be changed since the MN moves from a current mobile agent platform (MAP) to a neighboring MAP in a multiple MAP environment that supports regional registration and allows signal packets to be transmitted separately from data packets, the two MAPs share information about the MN with each other so as to provide a rapid IP handoff for the MN.

Furthermore, a high altitude aeronautical platform (HAAP) located higher than a base station (for example, in the stratosphere) or a virtual private network (VPN) can be used to transmit signal packets for IP handoff between such MAPs so as to transmit signal packets for IP handoff without delay by data packet (i.e., a head of line (HOL) blocking phenomenon can be prevented), so that IP handoff can be performed rapidly. Moreover, unlike a convention regional registration method using a gateway foreign agent (GFA), a registration request message of an MN is transmitted from an FA to an HA without modification so that MNs not compatible with a GFA scheme can be rapidly handed off in the present invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates mobile agent platforms (MAPs) for IP handoff that have hexagonal coverage areas like conventional code division multiple access (CDMA) cells according to an embodiment of the present invention;

FIG. 2 illustrates an MAP, MAPs neighboring the MAP, coverage areas of MAs adjacent to the neighboring MAPs, and coverage areas of MAs not adjacent to the neighboring MAPs according to an embodiment of the present invention.

FIG. 3 is a view illustrating an exemplary structure for IP handoff of an MN between plural MAPs according to an embodiment of the present invention;

FIG. 4 illustrates a standard format of a registration request message transmitted from an MN to an HA through an FA having a coverage area in which the MN is currently located, according to an embodiment of the present invention;

FIG. 5 illustrates a standard format of a registration reply message transmitted from an HA to an MN in response to a registration request message as illustrated in FIG. 4, according to an embodiment of the present invention;

FIG. 6 is a flowchart for explaining an IP handoff method when an MN moves from a coverage area of the MAP 301 to a coverage area of the MAP 302 in FIG. 3, according to an embodiment of the present invention;

FIG. 7 is a flowchart for explaining a method for providing IP handoff between the MAPs shown in FIGS. 1, 2, 3, and 6, according to an embodiment of the present invention;

FIG. 8 is a flowchart for explaining operation S632 of FIG. 7 in more detail, according to an embodiment of the present invention;

FIG. 9 is a flowchart for explaining a method for an MAP to receive entry information from a neighboring MAP for a border list of the MAP according to an embodiment of the present invention; and

FIGS. 10 and 11 are flowcharts for explaining a method for processing an MN registration request message received from a neighboring MAP and a method for processing an MN registration reply message received from a neighboring MAP according to embodiments of the present invention.

### BEST MODE FOR CARRYING OUT THE INVENTION

Exemplary embodiments of the present invention will now be described in detail with reference to the accompanying drawings. In the drawings, like reference numerals denote like elements. In the following description, well-known functions or constructions are not described in detail since they would obscure the invention in unnecessary detail

According to the invention, when an Internet (IP) address of a mobile node (MN) is to be changed since the MN moves from a current mobile agent platform (MAP) to a neighboring MAP in a multiple MAP environment that supports regional registration and allows signal packets to be transmitted separately from data packets, the two MAPs share information about the MN with each other so as to provide a rapid IP handoff for the MN. Furthermore, a high altitude aeronautical platform (HAAP) located higher than a base station (for example, in the stratosphere) or a virtual private network (VPN) can be used to transmit signal packets for IP handoff between such MAPs so as to transmit signal packets for IP handoff without delay by data packet (i.e., a head of line (HOL) blocking phenomenon can be prevented), so that IP handoff can be performed rapidly. Moreover, unlike a convention regional registration method using a gateway foreign agent (GFA), a registration request message of an MN is transmitted from an FA to an HA without modification so that MNs not compatible with a GFA scheme can be rapidly handed off in the present invention.

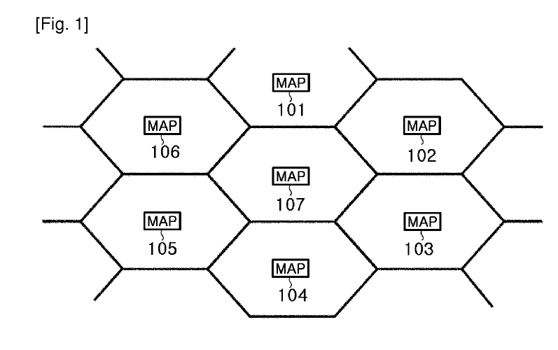

FIG. 1 illustrates MAPs for IP handoff that have hexagonal coverage areas like conventional code division multiple access (CDMA) cells according to an embodiment of the present invention.

Referring to FIG. 1, a plurality of neighboring MAPs is used for IP handoff instead of using a conventional GFA. For example, coverage areas of the MAPs have a hexagonal shape like the shape of a conventional CDMA cell.

As shown in FIG. 1, a maximum of six MAPs 101 to 106 can be arranged around a given MAP 107. In this case, a plurality of Mobile agents (MAs) exists inside the coverage area of the given MAP 107. In side the coverage area of the given MAP 107, some of the MAs may be adjacent to the neighboring MAPs 101 to 106, and the other may exist at a center portion away from the neighboring MAPs 101 to 106.

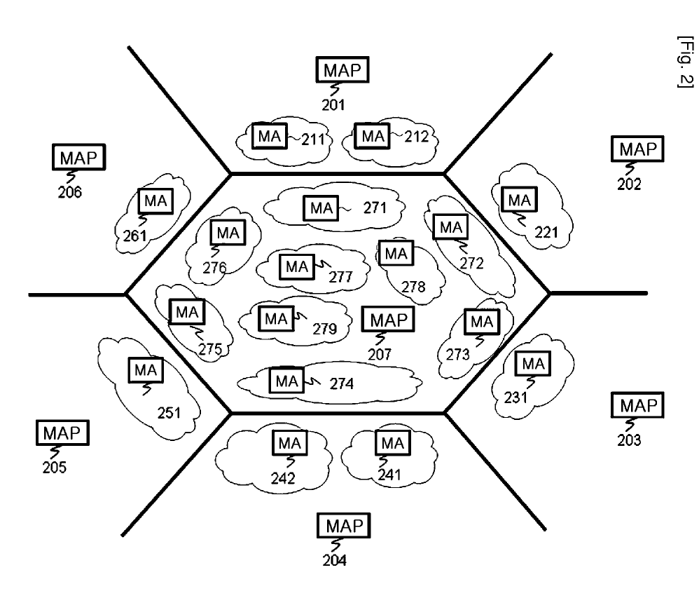

FIG. 2 illustrates an MAP, MAPs neighboring the MAP, coverage areas of MAs adjacent to the neighboring MAPs, and coverage areas of MAs not adjacent to the neighboring MAPs according to an embodiment of the present invention.

Referring to FIG. 2, each MA is disposed inside its coverage area. When an MN registered as a subscriber of an MA moves into the coverage area of the MA and starts operation, the MA operates as an HA of the MN. On the other hand, when an MN not registered as a subscriber of an MA moves into the coverage area of the MA and requests a service of the MA, the MA operates as an FA of the MN.

Referring again to FIG. 2, inside the coverage area of an MAP 207, an MA 271 is adjacent to the coverage area of an MAP 201, and an MA 272 is adjacent to the coverage area of an MAP 202. Further, an MA 273 is adjacent to the coverage area of an MAP 203, and an MA 274 is adjacent to the coverage area of an MAP 204. Further, an MA 275 is adjacent to the coverage area of an MAP 205, and an MA 276 is adjacent to the coverage area of an MAP 206.

On the other hand, MAs 277, 278, 279 located inside the coverage area of the MAP 207 are not adjacent to the MAPs 201 to 206 neighboring the MAP 207.

When an MN located inside the coverage area of the MA 277, 278, or 279 moves out of the coverage area of the MAP 207, the MN must pass through the coverage area of an MA adjacent to the coverage area of the MAP 201, 202, 203, 204, 205, or 206. For example, when an MN moves from the coverage area of the MA 277 to the coverage area of the MAP 201, the MN has to pass through the coverage area of the MA 271. Then, the MN can enter the coverage area of the MA 211 or 212.

The MAs 211 and 212 located in the coverage area of the MAP 201 is adjacent to the coverage area of the MAP 207. Therefore, when an MN moves from a coverage area of an MA (not shown) located inside the coverage area of the MAP 201 to the coverage area of the MAP 207, the MN has to move to the coverage area of the MAP 207 through the coverage area of the MA 211 or 212.

Each of the MAPs 201 to 207 includes a visitor list, a temporary list, and an additional border list. The MAP 207 prepares a list of visitors to the MA 271 using MN entries of its visitor list and sends the visitor list of the MA 271 to the MAP 201. Here, the visitor list of the MA 271 denotes a list containing entries of MNs that have moved into the coverage area of the MA 271 and successively registered with the MA 271.

In the same manner, the MAP 207 sends a visitor list of the MA 272 to the MAP 202, a visitor list of the MA 273 to the MAP 203, a visitor list of the MA 274 to the MAP 204, a visitor list of the MA 275 to the MAP 205, and a visitor list of the MA 276 to the MAP 206.

The MAP 207 receives visitor lists of the MAs 211 and 212 from the MAP 201 and stores the received visitor lists in its border list. In the same manner, the MAP 207 receives a visitor list of the MA 221 from the MAP 202, a visitor list of the MA 231 from the MAP 203, visitor lists of the MAs 241 and 242 from the MAP 204, a visitor list of the MA 251 from the MAP 205, and a visitor list of the MA 261 from the MAP 206. Then, the MAP 207 stores the received visitor lists in its border list.

In this way, all the MAPs of FIG. 2 such as the MAPs 201 to 206 send visitor lists of their MAs to MAPs located adjacent to the MAs. Further, all the MAPs of FIG. 2 receive visitor lists of MAs that are not located in the coverage areas of the MAPs but close to the coverage areas of the MAPs. Then, the MAPs store the received visitor lists in their border lists, respectively.

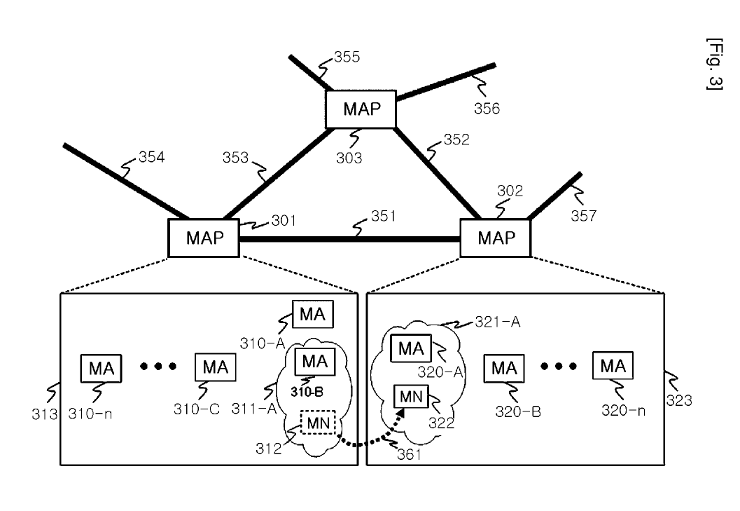

FIG. 3 is a view illustrating an exemplary structure for IP handoff of an MN between plural MAPs according to an embodiment of the present invention.

Referring to FIG. 3, reference numerals 351 to 357 denote paths (links) defined between MAPs to transmit signal packets for IP handoff. The links are established using an HAAP or VPN.

That is, in the current embodiment, an HAAP located higher than a conventional base station (for example, the HAAP is located in the stratosphere) or a VPN is used for establishing links between MAPs to transmit signal packets for IP handoff, instead of transmitting the IP-handoff signal packets using existing network paths used for transmitting data packets. Therefore, IP handoff can be rapidly performed. Owing to this configuration, signal packets for IP handoff are not delayed by data packets (i.e., head of line (HOL) blocking can be prevented), and thus rapid IP handoff can be possible. Furthermore, unlike in a conventional regional registration method using a GFA, a registration request message is transmitted from an FA to an HA without modification according to the current embodiment. Thus, the current embodiment can be applied to MNs not compatible with the GFA method.

The number of links for IP handoff can be established up to six between an MAP and MAPs neighboring the MAP when coverage areas of the MAPs are configured as illustrated in FIG. 1. In FIG. 3, reference numeral 313 denotes a coverage area of an MAP 301. Although the coverage area 313 of the MAP 301 has a hexagonal shape like those of MAPs in FIGS. 1 and 2, the coverage area 313 is simply drawn into a rectangular shape. Further, reference numeral 323 denotes a coverage area of an MAP 302. Although the coverage area 323 of the MAP 302 has a hexagonal shape, the coverage area 313 is simply drawn into a rectangular shape.

In FIG. 3, reference numerals 310-A to 310-n denote MAs located in the coverage area 313 of the MAP 301. Further, reference numerals 320-A to 320-n denote MAs located in the coverage area 323 of the MAP 302.

In addition, in FIG. 3, a cloud-shape coverage area of the MA 310B is denoted by reference numeral 311-A, and a cloud-shape coverage area of the MA 320-A is denoted by reference numeral 321-A. Coverage areas of other MAs are not shown in FIG. 3 for clarity.

The coverage areas of the MAs 310-A and 310-B of the MAP 301 are adjacent to the MAP 302, and the coverage area 321-A of the MA 320-A of the MAP 302 is adjacent to the MAP 301. The coverage areas of the MAs 310-C to 310-n of the MAP 301 are not adjacent to the MAP 302, and the coverage areas of the MAs 320-B to 320-n are not adjacent to the MAP 301.

Therefore, when an MN 312 moves from the coverage area 313 of the MAP 301 to the coverage area 323 of the MAP 302, the MN 312 has to pass through the coverage area of the MA 310-A or 310-B so as to enter the coverage area 321-A of the MA 320-A.

In FIG. 3, the same MN is indicated by a dashed line using reference numeral 312 and a solid line using reference numerals 322. That is, when the MN is located in the coverage area 311-A of the MA 310B of the MAP 301, the MN is denoted by reference numeral 312 using a dashed line. When the MN moves from the coverage area 311-A of the MA 310B of the MAP 301 to the coverage area 321-A of the MA 320A of the MAP 302 as shown by arrow 361, the MN is denoted by reference numeral 322 using a solid line.

In the case shown in FIG. 3, a border list of the MAP 301 includes a list of visitors to the MA 320-A, and a border list of the MAP 302 includes a list of visitors to the MA 310-A and a list of visitors to the MA 310-B. Therefore, when the MN 312 is located in the coverage area 311-A of the MA 310-B, the border list of the MAP 302 includes an entry corresponding to the MN 312.

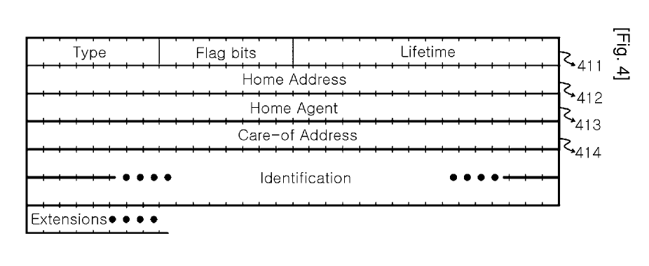

FIG. 4 illustrates a standard format of a registration request message transmitted from an MN to an HA through an FA having a coverage area in which the MN is currently located, according to an embodiment of the present invention.

In the current embodiment, an MN transmits the registration request message shown in FIG. 4 to an HA through an FA.

Referring to FIG. 4, the registration request message for IP handoff includes: a head 411 having a message type section, a flag bits section, and a lifetime section; a home address 412 of the MN; a address of home agent 413; and a care-of address(CoA) 414 of the FA.

The lifetime section can be modified by the HA.

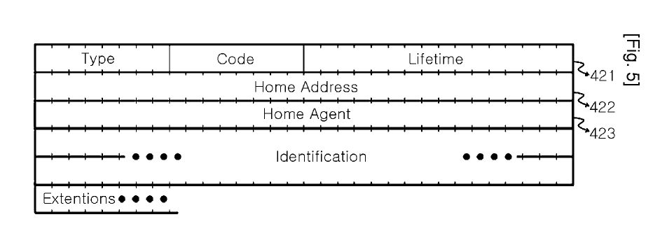

FIG. 5 illustrates a standard format of a registration reply message transmitted from an HA to an MN in response to a registration request message as illustrated in FIG. 4, according to an embodiment of the present invention.

In the current embodiment, an HA transmits the registration reply message shown in FIG. 5 to an MN through an FA.

Referring to FIG. 5, the registration reply message includes: a head 421 having a message type section, a code section, and a lifetime section; a home address 422 of the MN; and a home agent 423 of the MN.

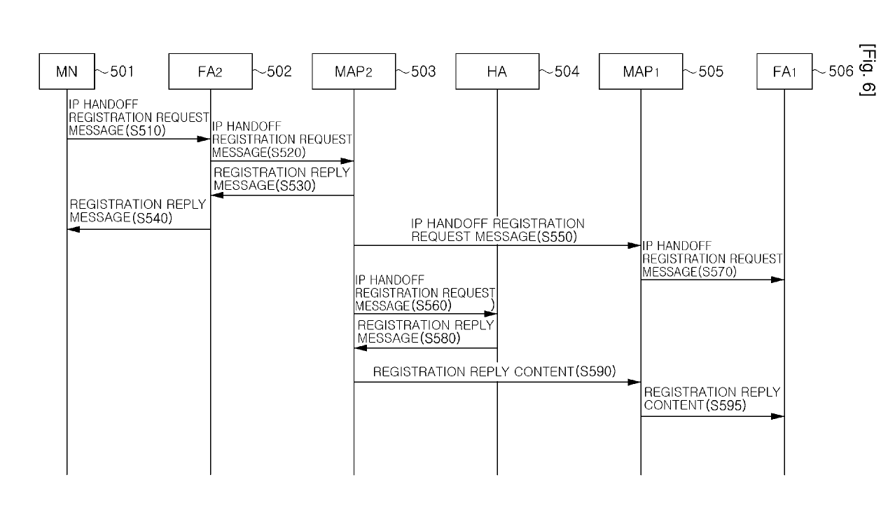

FIG. 6 is a flowchart for explaining an IP handoff method when the MN 312 moves from the coverage area 313 of the MAP 301 to the coverage area 323 of the MAP 302 in FIG. 3, according to an embodiment of the present invention.

In FIG. 6, an IP handoff of an MN from a coverage area of an FA to a coverage area of another FA is illustrated. In FIG. 6, an MN 501 corresponds to the MN 312 of FIG. 3, a FA2 502 corresponds to the MA 320-A of FIG. 3, and an MAP2 503 corresponds to the MAP 302 of FIG. 3. Further, in FIG. 6, an HA 504 corresponds to any one of MAs of the MAPs 301, 302, and 303. Alternatively, the HA 504 may correspond to an MA not included in the MAPs 301, 302, and 303. In FIG. 6, an MAP1 505 corresponds to the MAP 301, and an FA1 506 corresponds to the MA 310-B of FIG. 3.

When the MN 501 moves from a coverage area of the MAP1 505 to a coverage area of the MAP2 503, the MN 501 sends a registration request message (refer to FIG. 4) for IP handoff to the FA2 502 located in the coverage area of the MAP2 503 (S510).

The FA2 502 transmits the registration request message received from the MN 501 to the MAP2 503 (S520).

After receiving the registration request message, the MAP2 503 determines whether the MN 501 is listed in its border list. This determination can be made based on a home address of the MN 501. The MAP2 503 immediately transmits a registration reply message to the FA2 502 in response to the registration request message (S530).

After receiving the registration reply message, the FA2 502 transmits the received registration reply message to the MN 501 (S540).

After that, when the MAP2 503 recognizes that the MN 501 has moved from the coverage area of the MAP1 505, the MAP2 503 sends the registration request message to the MAP1 505 (S550). Further, the MAP2 503 sends the registration request message to the HA 504 (S560).

When the MAP1 505 receives the registration request message from the MAP2 503, the MAP1 505 finds a home address of the MN 501 from its visitor list so as to send the registration message to the FA1 506 that manages an area in which the MN 501 is located (S570).

The registration request message transmitted in operations S510 through S570 is a message generated by the MN 501. That is, unlike a conventional regional registration method, the same registration request message is used in the current embodiment.

Meanwhile, the HA 504 sends a registration reply message to the MAP2 503 in response to the registration request message received from the MAP2 503 (S580).

The MAP2 503 modifies its list using the registration reply message received from the HA 504. Further, the MAP2 503 transmits the contents of the registration request message received from the HA 504 to the MAP1 505 (S590).

When the MAP1 505 receives the contents of the registration request message from the MAP2 503, the MAP1 505 transmits the received message contents to the FA1 506 (S595). Here, the MAP1 505 deletes an entry of the MN 501 from its visitor list.

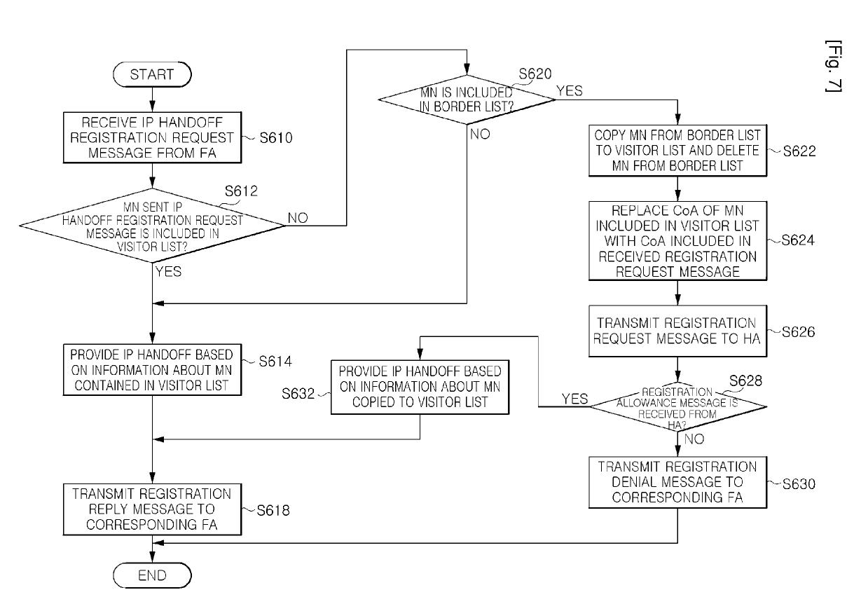

FIG. 7 is a flowchart for explaining a method for providing IP handoff between the MAPs shown in FIGS. 1, 2, 3, and 6, according to an embodiment of the present invention.

An MAP receives a registration request message for IP handoff from an MN through an FA (S610). Next, the MAP determines whether the MN sent the registration request message is included in its visitor list (S612). If the MN is included in the visitor list, the MAP provides an IP handoff service for the MN based on information about the MN contained in the visitor list (S614). Next, the MAP sends a registration reply message to the FA through which the registration request message is received (S618).

Meanwhile, if the MN sent the registration message is not included in the visitor list of the MAP, the MAP determines whether the MN is included in its border list (S620). This determination can be easily made using a home address (refer to 412 of FIG. 4) of the MN contained in the border list.

If the MN is not included in the border list, the MAP determines that the MN visits the MAP for the first time and goes to operation S614 where the MAP performs an initial procedure for an IP handoff of the MN.

If the MN is included in the border list, the MAP copies information about the MN from the border list to the visitor list and deletes an entry of the MN from the border list (S622).

The MAP replaces a CoA of an FA included in the information about the MN copied to the visitor list with a CoA included in the registration request message received from the FA in operation S610 (S624). Next, the MAP sends the registration request message received from the FA in operation 610 to an HA of the MN and then waits a response to the message from the HA (S626).

The MAP determines whether a registration reply message is received from the HA in response to the registration request message (S628). If it is determined that the registration reply message is a registration allowance message, the MAP provide an IP handoff service for the MN based on the information about the MN copied to the visitor list (S632). On the other hand, if it is determined that the registration reply message is a registration denial message, the MAP sends a registration denial message to the FA through which the registration request message has sent from the MN (S630).

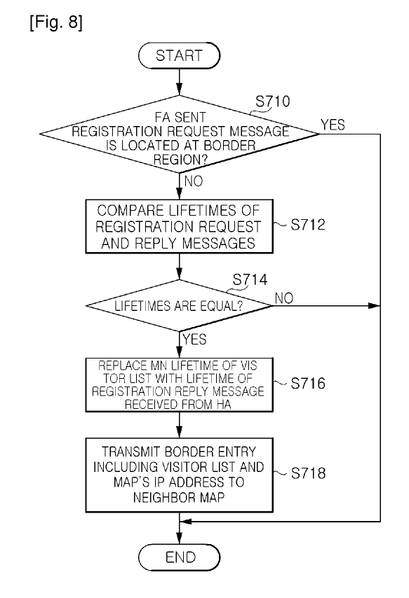

FIG. 8 is a flowchart for explaining operation S632 of FIG. 7 in more detail, according to an embodiment of the present invention.

When the MAP receives the registration allowance message from the HA, the MAP determines whether the FA that has sent the registration request message is located at a border region of its coverage area (S710). For example, referring to FIG. 3, the MAP 301 determines that an MA that has sent a registration request message is the MA 310-A or the MA 310-B. For another example, referring to FIG. 3, the MAP 302 determines that an MA that has sent a registration request message is the MA 320-A.

If the FA that has sent the registration request message is located at a border region, the MAP compares lifetime information included in the registration request message from the FA with that included in the registration reply message from the HA (S712).

The MAP determines whether the lifetime information of the registration request message is the same as that of the registration reply message (s714).

If the lifetime information of the registration request message is not the same as that of the registration reply message, the MAP replaces lifetime information of the MN included in its visitor list with the lifetime information of the registration reply message (S716). Further, the MAP stores its visitor list and address (IP address) in a border entry and sends the border entry to a corresponding neighbor MAP (S718). Here, when the MAP sends the border entry, the MAP informs the neighbor MAP that the entry is a border entry.

Meanwhile, in operation 714, if the lifetime information of the registration request message is the same as that of the registration reply message, the procedure goes to operation S618 of FIG. 7. Further, in operation 710, if the FA that has sent the registration request message is not located at a border region, the procedure goes to operation S618 of FIG. 7.

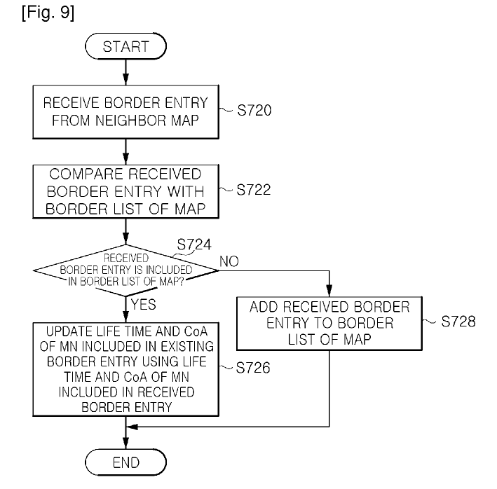

FIG. 9 is a flowchart for explaining a method for an MAP to receive entry information from a neighboring MAP for a border list of the MAP according to an embodiment of the present invention.

Referring to FIG. 9, an MAP receives a border entry and a registration request message of an FA from a neighboring MAP (S720). The MAP compares the received border entry with its border list (S722). This comparison can be easily done using an MN home address included in the border entry.

The MAP determines whether the received border entry is included in its border list (that is, the MN home address of the received border entry is included in the border list of the MAP) (S724). If the received border entry is included in the border list of the MAP, the MAP updates information about lifetime and CoA of an MN included in the border entry of its border list using lifetime and CoA of an MN included in the received border entry (S726).

If the received border entry is not included in the border list of the MAP, the MAP adds the received border entry to its border list (S728).

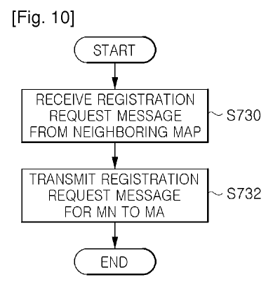

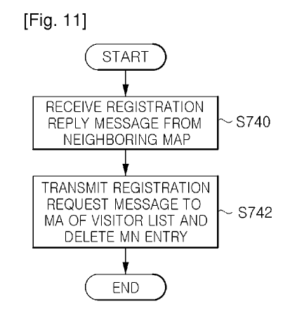

FIGS. 10 and 11 are flowcharts for explaining a method for processing an MN registration request message received from a neighboring MAP and a method for processing an MN registration reply message received from a neighboring MAP according to embodiments of the present invention.

Referring to FIG. 10, an MAP receives a registration request message from a neighboring MAP (S730). If the registration request message is a message requesting a registration of an MN, the MAP searches its visitor list so as to send a registration request message to a corresponding MA for the registration of the MN (S732). Here, the corresponding MA can be easily searched using a home address of the MN.

Referring to FIG. 11, an MAP receives a registration reply message for an MN from a neighboring MAP (S740). The MAP searches its visitor list to find an entry corresponding to the MN. If the entry corresponding to the MN is found, the MAP delivers the registration reply message to a corresponding MA and deletes the entry corresponding to the MN from its visitor list (S742).

While the present invention has been shown and described in connection with the preferred embodiments, it will be apparent to those skilled in the art that modifications and variations can be made without departing from the spirit and scope of the invention as defined by the appended claims.

1. A method for a mobile agent platform (MAP) to provide an Internet protocol (IP) handoff, the method comprising:
receiving a registration request message for an IP handoff from a mobile node (MN) in a network including a plurality of MAPs;
sharing information about the MN with an MAP managing an area in which the MN is located before through a signal packet path, the signal packet path being established separately from a data packet path for transmitting signal packets associated with IP handoff; and
providing an IP handoff for the MN based on the shared information.

2. The method according to claim 1, wherein the signal pack path is established using one of a high altitude aeronautical platform (HAAP) located in the stratosphere and a virtual private network (VPN).

3. The method according to claim 1, wherein the sharing of the information about the MN comprises receiving information about the MN from the MAP managing the area in which the MN is located before by using the registration request message received from the MN.

4. The method according to claim 1, wherein the registration request message comprises:
a head including information about a message type, flag bits, and a lifetime;
a home address of the MN;
a address of home agent; and
a care-of address (CoA) of a foreign agent (FA).

5. A method for an MAP to provide an IP handoff, the method comprising:
receiving a registration request message for an IP handoff from an MN in a network including a plurality of MAPs;
determining whether an entry corresponding to the MN is included in a border list;
transmitting the registration request message to an MAP managing an area in which the MN is located before and a home agent (HA);
receiving a registration reply message from the HA in response to the registration request message;
adding an entry of the MN to a visitor list after checking the received registration reply message; and
providing an IP handoff for the MN based on the entry of the MN added to the visitor list.

6. A method for an MAP to provide an IP handoff, the method comprising:
receiving a registration request message for an IP handoff from an MN through an FA;
determining whether the MN is included in a visitor list;
if the MN is not included in the visitor list, determining whether the MN is included in a border list;
if the MN is included in the border list, transmitting the registration request message to an HA based on information about the MN; and
providing an IP handoff for the MN based on information about the MN according to a registration allowance message received from the HA in response to the registration request message.

7. The method according to claim 6, the transmitting of the registration request message comprises:
copying information about the MN from the border list to the visitor list and deleting the information about the MN from the border list;
replacing a CoA of an FA included in the information about the MN copied to the visitor list with a CoA included in the registration request message received from the MN through the FA; and
after transmitting the registration request message to the HA of the MN, waiting a registration reply message from the HA in response to the registration request message.

8. The method according to claim 7, wherein the providing of the IP handoff comprises:
receiving a registration reply message from the HA in response to the registration request message;
if the registration reply message is a registration allowance message, providing an IP handoff for the MN based on information about the MN; and
if the registration reply message is a registration denial message, transmitting a registration denial message to the FA through which the registration request message is received.

9. The method according to claim 6, wherein the providing of the IP handoff comprises:
when a registration allowance message is received from the HA, determining whether the FA is located at a border region of a coverage area of the MAP;
if the FA is located at a border region, comparing lifetime information included in the registration request message with lifetime information included in a registration reply message received from the HA in response to the registration request message;
if the life time information of the registration request message is not equal to the lifetime information of the registration reply message, replacing lifetime information of the MN included in a visitor list with the lifetime information of the registration reply message; and
storing the visitor list and an IP address of the MAP in a border entry so as to send the border entry to a corresponding neighbor MAP together with information indicating that the entry is a border entry.

10. The method according to claim 9, wherein the providing of the IP handoff further comprises:
receiving a border entry and a registration request message of the FA from the neighbor MAP;
determining whether the received border entry is included in the border list; and
if so, replacing information about a lifetime and a CoA of an MN included in the border entry of the border list with a lifetime and a CoA of an MN included in the received border entry.

11. The method according to claim 6, wherein the registration request message comprises:
a head including information about a message type, flag bits, and a lifetime;
a home address and a home agent of the MN; and
a care-of address (CoA) of the FA.
